(19) United States
(12) Patent Application Publication
(10) Pub. No.: US 2013/0170875 A1
(43) Pub. Date: Jul. 4, 2013

(54) TONER VESSEL HAVING IMPROVED PADDLE FOR BREAKING COMPACTED TONER

(71) Applicants: Rodney Evan Sproul, Lexington, KY (US); Kalyan Vedantam, Peoria, IL (US)

(72) Inventors: Rodney Evan Sproul, Lexington, KY (US); Kalyan Vedantam, Peoria, IL (US)

(21) Appl. No.: 13/341,792

(22) Filed: Dec. 30, 2011

(51) Int. Cl. G03G 15/08

(52) U.S. Cl. 399/263

(57) ABSTRACT

A toner paddle for a toner vessel containing toner according to one example embodiment includes a drive shaft defining an axis of rotation for the paddle. The paddle also includes a first set of radially aligned breaker bars, a second set of radially aligned breaker bars radially offset from the first set of breaker bars by about 90 degrees, and a third set of radially aligned breaker bars radially offset from the second set of breaker bars by about 180 degrees. Each of the sets of breaker bars includes a plurality of radially extending breaker bars axially spaced along the drive shaft. The rotation of the drive shaft results in the rotation of the sets of breaker bars into, through, and out of engagement with the toner within the vessel.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The invention relates to a toner vessel having toner that employs a paddle for engaging with the toner therein, and, more particularly having a paddle with the capability of breaking compacted toner and agitating the toner.

2. Background Information

When a toner vessel is allowed to sit undisturbed for an extended period of time, the toner contained therein settles and compacts into a semi-solid mass. Settling occurs, for example, when the toner vessel is shipped and then stored for a long period of time. The toner particles start to compact and become difficult to break apart as a result of the long period of time that the toner vessel sits still. The environmental conditions during shipping also contribute to toner settling. Another example of toner settling is during long periods of printer inactivity such as during the summer in a school when the printer may go unused for several months.

In some toner vessels, such as a toner cartridge, a torque based toner level sensing method is used to provide an indication for the customer when the toner cartridge is low or out of toner. In such devices, a one-sided paddle is incorporated within the toner cartridge to determine the torque at a known position to sense the level of toner in the interior of the toner cartridge. In most toner cartridges, the paddle is driven by a motor and gear train to rotate about the interior of the toner cartridge.

To break through the settled toner mass, toner vessels can be shipped with the paddle positioned in the middle of the toner in the interior of the vessel. This allows the paddle to break about half of the toner mass before it rotates around and has to break the other half. Occasionally however, gear cogging or the slipping of gear teeth occurs due to the amount of torque required to turn the paddle and break through the settled toner. As toner vessels are developed with increasing capacity to hold larger amount of toner, the torque applied to the paddle also increases and results in higher loads on the teeth of the gears. As a result, there is a need in the art to provide a toner vessel with a paddle that is able to break through and agitate toner even after long periods of inactivity.

### SUMMARY OF THE DISCLOSURE

A toner vessel according to one example embodiment includes a vessel sized to hold toner. A paddle is rotatably mounted within the vessel for mixing the toner. The paddle includes a drive shaft defining an axis of rotation for the paddle, a first set of radially aligned breaker bars, a second set of radially aligned breaker bars radially offset from the first set of breaker bars by about 90 degrees, and a third set of radially aligned breaker bars radially offset from the second set of breaker bars by about 180 degrees. Each of the sets of breaker bars includes a plurality of radially extending breaker bars axially spaced along the drive shaft. The rotation of the drive shaft results in the rotation of the sets of breaker bars into, through, and out of engagement with the toner within the vessel.

A toner paddle for a toner vessel containing toner according to one example embodiment includes a drive shaft defining an axis of rotation for the paddle. The paddle also includes a first set of radially aligned breaker bars, a second set of radially aligned breaker bars radially offset from the first set of breaker bars by about 90 degrees, and a third set of radially aligned breaker bars radially offset from the second set of breaker bars by about 180 degrees. Each of the sets of breaker bars includes a plurality of radially extending breaker bars axially spaced along the drive shaft. The rotation of the drive shaft results in the rotation of the sets of breaker bars into, through, and out of engagement with the toner within the vessel.

### BRIEF DESCRIPTION OF DRAWINGS

Features and advantages of the present disclosure are set forth herein by description of embodiments consistent with the present disclosure, which description should be considered in conjunction with the accompanying drawings.

FIG. 1 is a cutaway view of a prior art toner vessel having a rotatable paddle therein.

FIG. 2 is a perspective view of a rotatable paddle for breaking up settled toner according to one example embodiment.

FIG. 3 is a perspective view of a rotatable paddle for breaking up settled toner according to a second example embodiment.

FIG. 4 is a perspective view of a rotatable paddle for breaking up settled toner according to a third example embodiment.

FIG. 5 is a perspective view of a rotatable paddle for breaking up settled toner according to a fourth example embodiment.

FIG. 6A is a perspective view of a rotatable paddle having breaker bars that have an angled surface according to a one example embodiment.

FIG. 6B is a perspective view of a rotatable paddle having conical breaker bars according to a one example embodiment.

### DETAILED DESCRIPTION

The following description and drawings illustrate embodiments of the disclosure sufficiently to enable those skilled in the art to practice it. It is to be understood that the disclosure is not limited in its application to the details of construction and the arrangement of components set forth in the following description or illustrated in the drawings. The disclosure is capable of other embodiments and of being practiced or of being carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the disclosure encompasses the appended claims and all available equivalents. The following description is, therefore, not to be taken in a limited sense, and the scope of the disclosure as defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

As described in subsequent paragraphs, the specific mechanical configurations illustrated in the drawings are intended to illustrate example embodiments of the disclosure and other alternative mechanical configurations are possible.

Disclosed is a paddle rotatably mounted within the interior of a toner vessel for mixing toner having a variety of features that engage the toner in the toner vessel. The toner vessel may be utilized in an image forming apparatus which may include an electrophotographic device, a copier, a fax, an all-in-one device or multi-functional device.

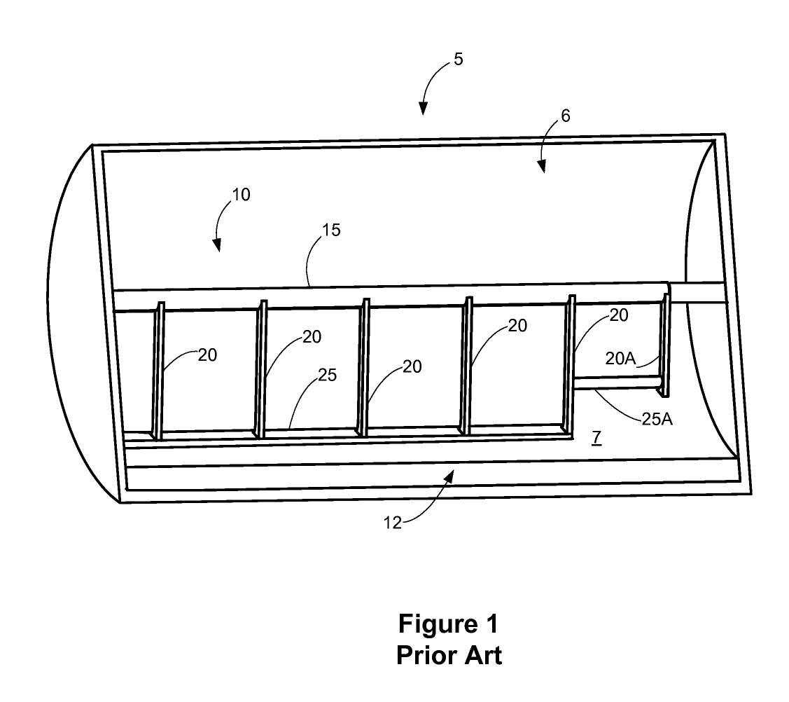

FIG. 1 shows a prior art toner vessel 5 having an interior 6 that is sized to hold a quantity of toner therein. A gear driven paddle 10 rotatably mounted within the interior 6 is used to move the toner to an exit 12. A plurality of radially aligned, axially spaced breaker bars 20 radially extend from a drive shaft 15 of paddle 10 in a cantilevered manner. A film strip 25 having a thickness and width similar to breaker bars 20 connects the distal ends of the breaker bars 20. The breakers bars 20 may have different lengths, as shown by the shorter bar 20A, to accommodate protrusions into the interior 6 that would not allow the longer bars 20 to pass when paddle 10 rotates. A film strip 25A connects the distal end of shorter bar 20A to a side of the adjacent bar 20. The strips 25, 25A help sweep toner from along the wall 7 of the interior 6. In some cases where the toner is allowed to sit or settle for some period of time, the toner particles compact and become difficult to break apart. As a result, gear cogging or the slipping of gear teeth may occur due to the amount of torque required to turn the paddle 10 through the settled toner.

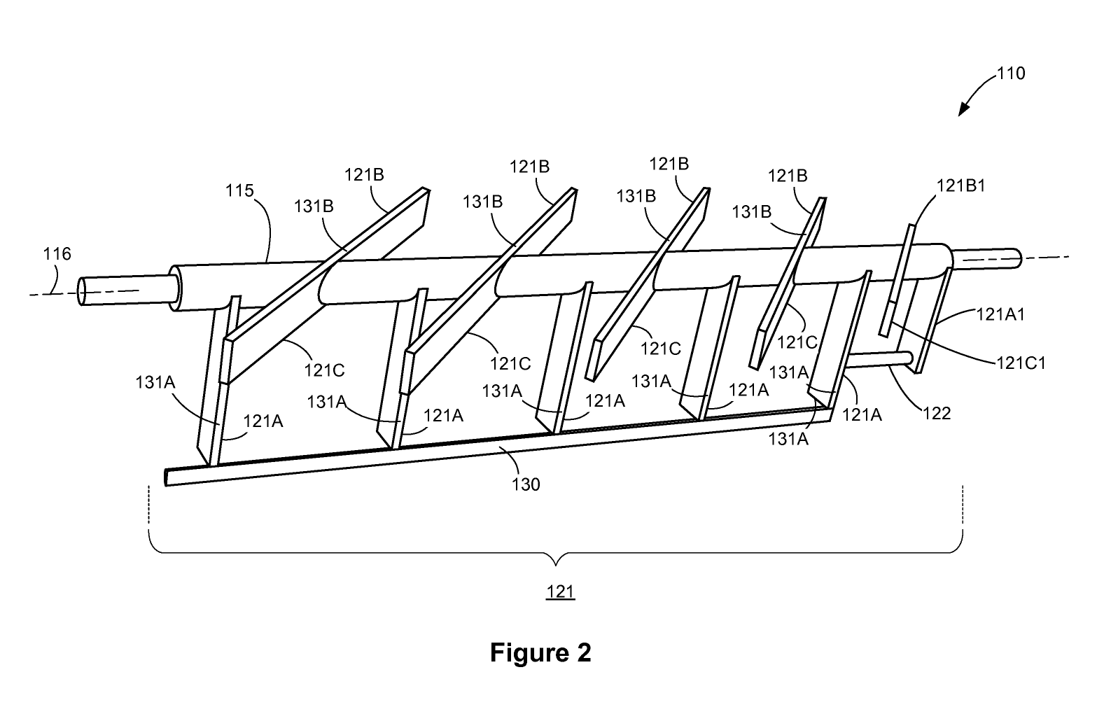

Referring to FIG. 2, a paddle 110 is illustrated according to one example embodiment. Paddle 110 includes a drive shaft 115 having an axis of rotation 116 and a plurality of sets of breaker bars generally indicated by the reference numeral 121 including a first set 121A, a second set 121B and a third set of breaker bars 121C. The breaker bars 121 may be molded unitarily with the drive shaft 115 or attached as separate components thereto. As the drive shaft 115 rotates, the breaker bars 121 rotate into, through, and out of engagement with the toner within the toner vessel 5 (FIG. 1).

The first set of breaker bars includes a plurality of axially spaced and radially aligned breaker bars 121A extending radially outward from the drive shaft 115. The breaker bars 121A in the first set extend from drive shaft 115 substantially perpendicular to axis of rotation 116. The first set of breaker bars 121A has a front surface 131A. The second set of breaker bars includes a plurality of generally planar, radially aligned and axially spaced bars 121B extending outward from the drive shaft 115 at an acute angle with respect to the axis of rotation 116. The second set of breaker bars 121B is rotated about 90 degrees from the first set of breaker bars 121A and positioned axially between breaker bars 121A. The third set of breaker bars includes a plurality of generally planar, radially aligned and axially spaced bars 121C extending outwardly from the drive shaft 115 at an acute angle to the axis of rotation 116. The third set of breaker bars 121C extends in an opposite direction to the second set of breaker bars 121B and is axially aligned therewith. The second and third sets of aligned breaker bars 121B and 121C can be formed as separate breaker bars or as a single set of breaker bars having a common front surface 131B. The paddle 110 may have shorter breaker bars 121A1, 121B1, and 121C1 near one or both of its ends to accommodate for protrusions into the interior 6 that would not allow the longer breaker bars 121 to pass by when paddle 110 is rotated.

A film strip 130 may be attached to the distal ends of the first set of breaker bars 121A to push toner to the exit 12 of the toner vessel 5 (FIG. 1). The film strip 130 may extend beyond one or both of the end breaker bars 121A as shown in FIG. 2. A film strip 122 may connect the distal end of shorter bar 121A1 to a side of the adjacent bar 121A. The film strips 122, 130 may be constructed from a resilient and durable polymer sheet or, alternatively, from a flexible metal. The film strips 122, 130 may be formed by a variety of techniques, including, but not limited to, various molding processes. In one embodiment, the material is 1 mil or 1 mm thick polyethylene terephthalate polyester (PET) plastic sheet (e.g., trade name MYLAR).

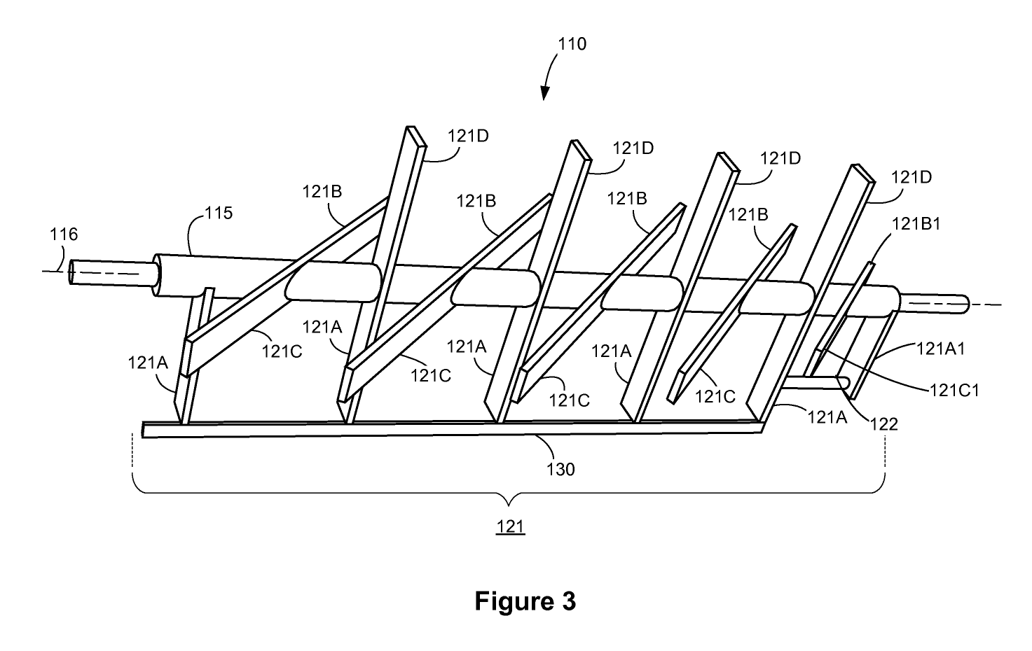

FIG. 3 shows another example embodiment of the paddle 110 having a plurality of breaker bars 121 comprised of four sets of breaker bars. In addition to the first, second, and third sets of breaker bars 121A, 121B, 121C shown in FIG. 2, in this embodiment, paddle 110 includes a fourth set of generally planar, radially aligned and axially spaced bars 121D. The breaker bars 121D of the fourth set are axially aligned with the first set of breaker bars 121A and extend outwardly from the drive shaft 115 in an opposite direction to the first set of breaker bars 121A. As discussed above, the paddle 110 may have shorter breaker bars 121A1, 121B1, and 121C1 near one or both of its ends. Further, the paddle 110 may include a film strip 130 that connects the distal ends of the first set of breaker bars 121A and a shorter film strip 122 that connects a distal end of shorter bar 121A1 to a side of the adjacent bar 121A.

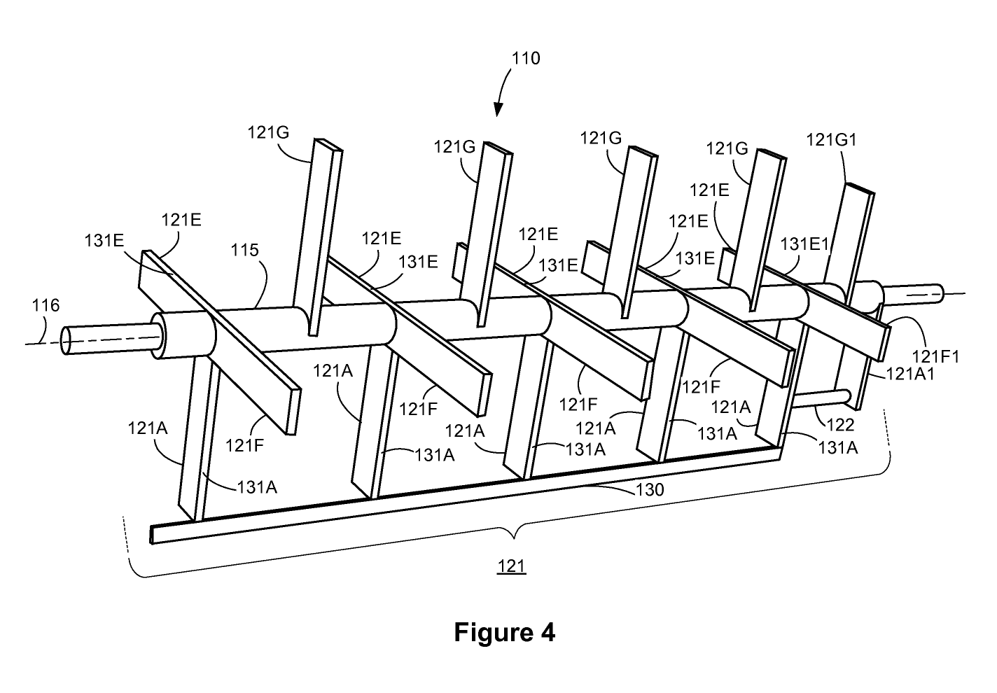

FIG. 4 shows another example embodiment of the paddle 110 having a plurality of breaker bars 121 comprised of four sets of breaker bars. In this embodiment, the paddle 110 has a first set of breaker bars 121A axially spaced apart from each other and radially cantilevered on the drive shaft 115. Each breaker bar 121A of the first set has a front surface 131A aligned to a first plane A (not shown). A second set of breaker bars 121E is radially cantilevered on the drive shaft 115 and axially aligned with the first set of breaker bars 121A. Each breaker bar 121E of the second set has a front surface 131E aligned to a second plane B (not shown) that is substantially orthogonal to the first plane A. A third set of breaker bars 121F is also radially cantilevered on the drive shaft 115 and axially aligned with the first and second sets of breaker bars 121A, 121E, respectively. The third set of breaker bars 121F extends radially outwardly in a direction opposite to that of the second set of breaker bars 121E. Each breaker bar 121F of the third set has a front surface 131F that is aligned to the second plane B. The first, second, and the third sets of breaker bars 121A, 121E, 121F form a series of T-shaped formations mounted on the drive shaft 115. A fourth set of breaker bars 121G is axially offset from the first, second, and third sets of breaker bars 121A, 121E, 121F. Each breaker bar 121G of the fourth set extends radially outwardly in a direction opposite to that of the first set 121A of breaker bars. As discussed above, the paddle 110 may have shorter breaker bars 121A1, 121E1, 121F1 and 121G1 near one or both of its ends. Further, the paddle 110 may include a film strip 130 attached to connect distal ends of the first set of breaker bars 121A, and a shorter film strip 122 connecting a distal end of bar 121A1 to a side of the adjacent bar 121A.

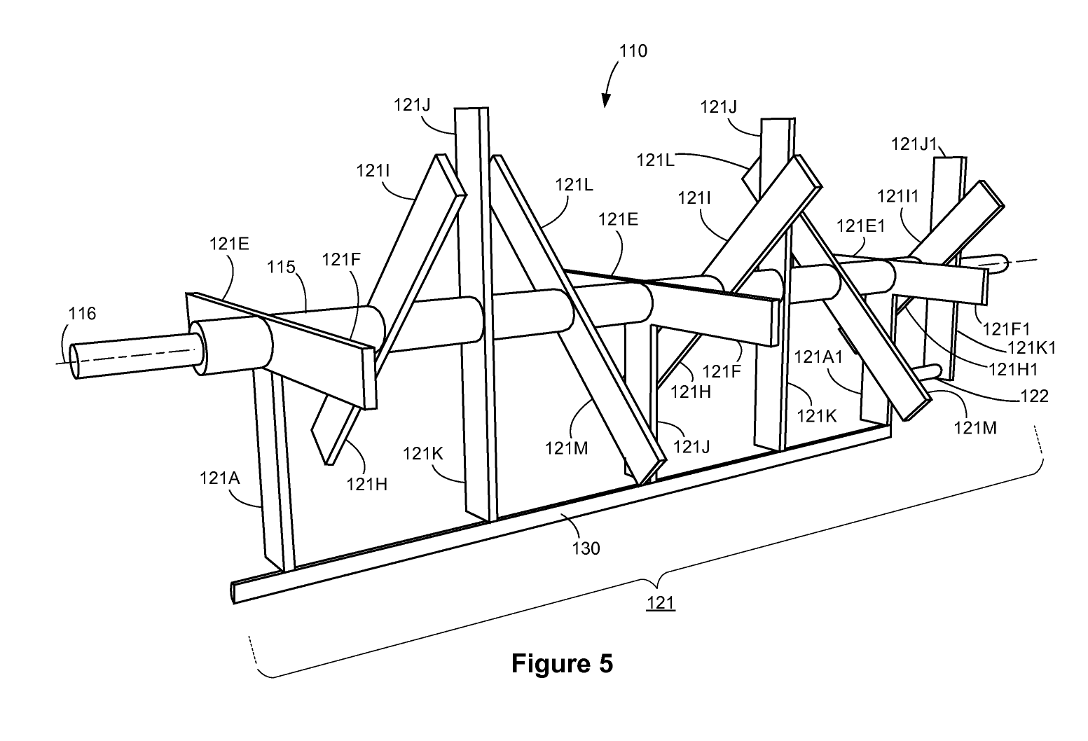

FIG. 5 illustrates another example embodiment of the paddle 110. In this embodiment, paddle 110 includes a series of T-shaped formations formed by breaker bars 121A, 121E and 121F as discussed above with respect to FIG. 4. Interspaced between each T-shaped formation are three I-shaped breaker bar formations. The first I-shaped breaker bar formation includes a fourth set of breaker bars 121H and a fifth set of breaker bars 121I that are axially aligned with each other and radially extend in opposite directions to form the I-shape. Breaker bars 121H are radially offset from the first set of breaker bars 121A by about 45 degrees and breaker bars 121I are radially offset from the first set of breaker bars 121A by about 135 degrees. The second I-shaped breaker bar formation includes a sixth set of breaker bars 121J and a seventh set of breaker bars 121K that are axially aligned with each other and radially extend in opposite directions to form the I-shape. The second I-shaped breaker bar formation is radially offset from the first I-shaped breaker bar formation formed by breaker bars 121H and 121I by about 45 degrees. Breaker bars 121K are radially aligned with breaker bars 121A of the first set and breaker bars 121J are radially offset from the first set of breaker bars 121A by about 180 degrees. The third I-shaped breaker bar formation includes an eighth set of breaker bars 121L and a ninth set of breaker bars 121M that are axially aligned with each other and radially extend in opposite directions to form the I-shape. The third I-shaped breaker bar formation is radially offset from the first I-shaped breaker bar formation formed by breaker bars 121H and 121I by about 45 degrees and radially offset from the second I-shaped breaker bar formation formed by breaker bars 121J and 121K by about 90 degrees. Breaker bars 121M are radially offset with breaker bars 121A of the first set by about 45 degrees and breaker bars 121L are radially offset from the first set of breaker bars 121A by about 135 degrees. As discussed above, the paddle 110 may have shorter breaker bars 121A1, 121E1, 121F1, 121H1, 121I1, 121J1, and 121K1. Further, the paddle 110 may include a film strip 130 attached to connect distal ends of the first set of breaker bars 121A, and a shorter film strip 122 connecting a distal end of bar 121K1 to a side of the adjacent bar 121A.

It will be realized that for the configurations shown in FIGS. 2-5, a film strip may be added to the distal ends of the various sets of breaker bars shown in those figures. The film strip can be in lieu of or in addition to film strip 130 shown in FIGS. 2-5. It will also be recognized that use of more than one film strip would increase the drag of the paddle 110 against the interior wall of the toner vessel requiring increased torque for rotation of the paddle 110.

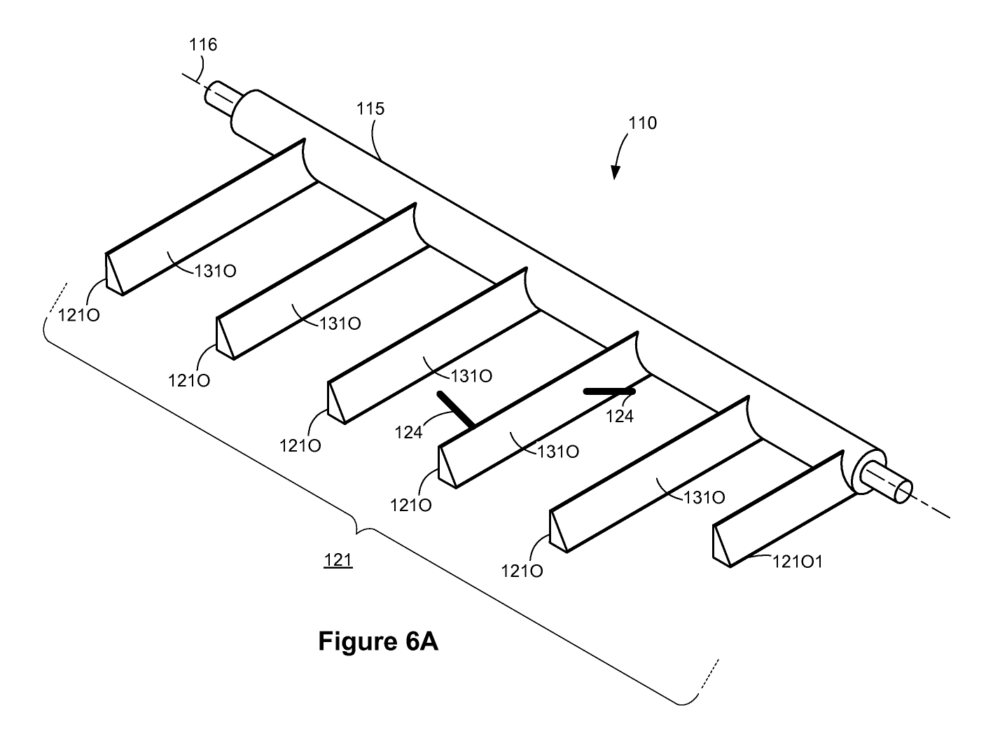

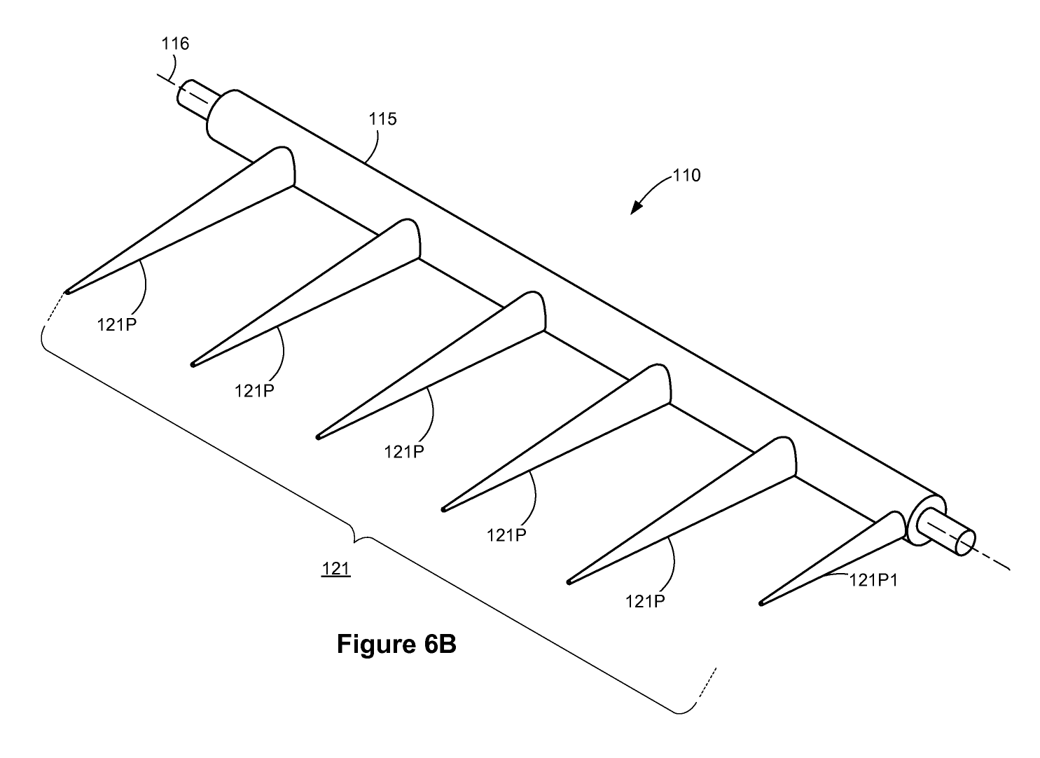

The breaker bars 121 may be of various geometrical shapes, for example, the breaker bars may be substantially cylindrical, rectangular, triangular, conical, etc. As shown in FIG. 6A the plurality of breaker bars 121 may include axially spaced and radially aligned breaker bars 121O having side surfaces 131O that are angled with respect to the drive shaft 115 for engaging with the toner. The angled surfaces 1310 aid in chipping apart and driving through compacted toner. FIG. 6B illustrates a plurality of breaker bars 121 comprised of axially spaced and aligned conical breaker bars 121P cantilevered from the drive shaft 115 and coming to a point at their distal ends.

The breaker bars 121 may extend radially outward as well as in other angular directions from the drive shaft 115 such that regardless of the position of the paddle 110, a portion of some of the plurality of breaker bars 121 are within the toner. Accordingly, the toner is already slightly broken up before the paddle 110 begins to rotate thus reducing the likelihood of gear cogging. Further, as shown in FIG. 6A, the plurality of breaker bars 121 may be provided with projections or arms 124 on the side surfaces of the bars 121 to assist with breaking up the toner in the reservoir 6 (FIG. 1). Projections 124 of various shapes and lengths extending generally in the axial direction of the drive shaft 115 may be used on the front surface, back surface, and/or a side surface of the breaker bars 121. The projections 124 may include any suitable geometry and may be used to increase the working area of the paddle 110. The paddle 110 may also have breaker bars 121 extending outwardly from the drive shaft 115 at an acute angle to the axis of rotation 116 as shown in FIG. 2. This allows the paddle 110 to slice through the toner mass diagonally and cover a larger working area as it rotates.

It can therefore be appreciated that the embodiments of the paddle illustrated and described herein may extend the ability of the paddle to engage, break, and mix the toner within the interior of the cartridge. However, numerous additional modifications and variations are possible in light of the above teachings. It is therefore to be understood that within the scope of the appended claims, the disclosure of this patent specification may be practiced otherwise than as specifically described herein.

What is claimed is:

1. A toner vessel, comprising:
a vessel sized to hold toner; and
a paddle rotatably mounted within the vessel for mixing the toner, the paddle comprising:
a drive shaft defining an axis of rotation for the paddle;
a first set of radially aligned breaker bars;
a second set of radially aligned breaker bars radially offset from the first set of breaker bars by about 90 degrees; and
a third set of radially aligned breaker bars radially offset from the second set of breaker bars by about 180 degrees,
wherein each of the sets of breaker bars comprises a plurality of radially extending breaker bars axially spaced along the drive shaft, and
wherein the rotation of the drive shaft results in the rotation of the sets of breaker bars into, through, and out of engagement with the toner within the vessel.

2. The toner vessel of claim 1, wherein the first, second, and third sets of breaker bars are axially aligned.

3. The toner vessel of claim 2, further comprising a fourth set of radially aligned breaker bars axially spaced from the first, second, and third sets of breaker bars and radially offset from the first set of breaker bars by about 180 degrees.

4. The toner vessel of claim 2, further comprising:
a fourth set and a fifth set of radially aligned breaker bars, the fourth set of breaker bars radially offset from the first set of breaker bars by about 45 degrees, the fifth set of breaker bars radially offset from the fourth set of breaker bars by about 180 degrees, wherein the fourth and fifth sets of breaker bars are axially aligned with each other and axially spaced from the first, second, and third sets of breaker bars;
a sixth set and a seventh set of radially aligned breaker bars, the sixth set of breaker bars radially aligned with the first set of breaker bars, the seventh set of breaker bars radially offset from the sixth set of breaker bars by about 180 degrees, wherein the sixth and seventh sets of breaker bars are axially aligned with each other and axially spaced from the first, second, third, fourth and fifth sets of breaker bars; and
an eighth set and a ninth set of radially aligned breaker bars, the eighth set of breaker bars radially offset from the first set of breaker bars by about 45 degrees and the fifth set of breaker bars by about 90 degrees, the ninth set of breaker bars radially offset from the eighth set of breaker bars by about 180 degrees, wherein the eighth and ninth sets of breaker bars are axially aligned with each other and axially spaced from the first, second, third, fourth, fifth, sixth and seventh sets of breaker bars.

5. The toner vessel of claim 1, wherein the second and third sets of breaker bars are axially aligned with each other, and each breaker bar of the second and third sets of breaker bars is positioned at an acute angle with respect to the drive shaft and axially spaced from adjacent breaker bars of the first set of breaker bars.

6. The toner vessel of claim 1, further comprising a film strip connecting at least two breaker bars in at least one of the sets of breaker bars at distal ends thereof, the film strip pushing the toner to an exit of the vessel during paddle rotation.

7. The toner vessel of claim 1, wherein each of the sets of breaker bars includes at least one shorter breaker bar positioned near an end of the driveshaft.

8. The toner vessel of claim 1, wherein at least one breaker bar in at least one of the sets of breaker bars has an angled surface along a portion of a length of the at least one breaker bar for engaging with the toner.

9. The toner vessel of claim 1, wherein at least one breaker bar in at least one of the sets of breaker bars has a conical shape.

10. The toner vessel of claim 1, wherein at least one breaker bar in at least one of the sets of breaker bars includes a plurality of projections extending from a side of the at least one breaker bar.

11. A toner paddle for a toner vessel containing toner comprising:
a drive shaft defining an axis of rotation for the paddle;
a first set of radially aligned breaker bars;
a second set of radially aligned breaker bars radially offset from the first set of breaker bars by about 90 degrees; and
a third set of radially aligned breaker bars radially offset from the second set of breaker bars by about 180 degrees,
wherein each of the sets of breaker bars comprises a plurality of radially extending breaker bars axially spaced along the drive shaft, and
wherein the rotation of the drive shaft results in the rotation of the sets of breaker bars into, through, and out of engagement with the toner within the vessel.

12. The paddle of claim 11, wherein the first, second, and third sets of breaker bars are axially aligned.

13. The paddle of claim 12, further comprising a fourth set of radially aligned breaker bars axially spaced from the first, second, and third sets of breaker bars and radially offset from the first set of breaker bars by about 180 degrees.

14. The paddle of claim 12, further comprising:
a fourth set and a fifth set of radially aligned breaker bars, the fourth set of breaker bars radially offset from the first set of breaker bars by about 45 degrees, the fifth set of breaker bars radially offset from the fourth set of breaker bars by about 180 degrees, wherein the fourth and fifth sets of breaker bars are axially aligned with each other and axially spaced from the first, second, and third sets of breaker bars;
a sixth set and a seventh set of radially aligned breaker bars, the sixth set of breaker bars radially aligned with the first set of breaker bars, the seventh set of breaker bars radially offset from the sixth set of breaker bars by about 180 degrees, wherein the sixth and seventh sets of breaker bars are axially aligned with each other and axially spaced from the first, second, third, fourth and fifth sets of breaker bars; and
an eighth set and a ninth set of radially aligned breaker bars, the eighth set of breaker bars radially offset from the first set of breaker bars by about 45 degrees and the fifth set of breaker bars by about 90 degrees, the ninth set of breaker bars radially offset from the eighth set of breaker bars by about 180 degrees, wherein the eighth and ninth sets of breaker bars are axially aligned with each other and axially spaced from the first, second, third, fourth, fifth, sixth and seventh sets of breaker bars.

15. The paddle of claim 11, wherein the second and third sets of breaker bars are axially aligned with each other, and each breaker bar of the second and third sets of breaker bars is positioned at an acute angle with respect to the drive shaft and axially spaced from adjacent breaker bars of the first set of breaker bars.

16. The paddle of claim 11, further comprising a film strip connecting at least two breaker bars in at least one of the sets of breaker bars at distal ends thereof, the film strip pushing the toner to an exit of the vessel during paddle rotation.

17. The paddle of claim 11, wherein each of the sets of breaker bars includes at least one shorter breaker bar positioned near an end of the driveshaft.

18. The paddle of claim 11, wherein at least one breaker bar in at least one of the sets of breaker bars has an angled surface along a portion of a length of the at least one breaker bar for engaging with the toner.

19. The paddle of claim 11, wherein at least one breaker bar in at least one of the sets of breaker bars has a conical shape.

20. The paddle of claim 11, wherein at least one breaker bar in at least one of the sets of breaker bars includes a plurality of projections extending from a side of the at least one breaker bar.
